(19) United States
(12) Patent Application Publication
(10) Pub. No.: US 2009/0236355 A1
(43) Pub. Date: Sep. 24, 2009

(54) CONTAINER STOPPER

(75) Inventor: Norma Catherine Matheson, Middle Park (AU)

Correspondence Address: CONNOLLY BOVE LODGE & HUTZ LLP, 1875 EYE STREET, N.W., SUITE 1100, WASHINGTON, DC, 20006, US

(73) Assignee: PROCEL PTY LTD, MELBOURNE (AU)

(21) Appl. No.: 12/211,541

(22) Filed: Sep. 16, 2008

Related U.S. Application Data
(63) Continuation-in-part of application No. 10/482,384, filed on Dec. 31, 2003, now abandoned.

(30) Foreign Application Priority Data
Jul. 4, 2001 (AU) PR 61151
Nov. 26, 2001 (AU) PR 9097

(51) Int. Cl. B65D 39/00; B32B 37/12

(52) U.S. Cl. 220/801; 215/364; 156/60

(57) ABSTRACT

A container stopper comprising a compressible body (2) having at least one end for insertion into an opening of a container, and a film (1) on the end of the compressible body (2) for providing a protective layer between the compressible body and the container contents; wherein at least a region at the end of the compressible body has at least one property whereby upon compression of the body for insertion into an opening of a container said region compresses without substantially adversely affecting the protective layer provided by the film (1).

### REFERENCE TO RELATED APPLICATIONS

This application is a Continuation-In-Part of copending application Ser. No. 10/482,384 filed on Dec. 31, 2003 and for which priority is claimed under 35 U.S.C. § 120, which is also the National Stage of International Application No. PCT/AU02/000877 filed on Jul. 3, 2002; and claims priority to Application No. PR6115 filed in Australia on Jul. 4, 2001 and Application No. PR9097 filed in Australia on Nov. 26, 2001 under 35 U.S.C. § 119; the entire contents of all are hereby incorporated by reference.

### FIELD OF THE INVENTION

The present invention relates to improved stoppers for stoppering openings in containers. In particular, the present invention relates to improvements to container stoppers that have a film on at least one end to protect the stopper from the contents of the container the stopper is utilised in. The stoppers of the invention are particularly useful as stoppers for openings in containers of fluids such as wine. The invention also relates to an improved method of producing container stoppers such as the container stoppers of the invention and packaged products, particularly packaged fluid products, in which a stopper of the invention is incorporated.

### BACKGROUND OF THE INVENTION

A number of products are packaged in containers where the openings in the container are stoppered. In these circumstances, it is typical that the stopper forms an interference fit with the container opening. One of the most common products to be packaged in this way is wine although other fluid products are packaged similarly. Traditionally, wine has been stored in bottles sealed with cork stoppers. Cork stoppers have been used in the wine industry for a variety of reasons most of which relate to the exceptional natural qualities of cork as a stopper. By way of example, cork is durable, resilient, free from rotting, is sparingly permeable to gas, is predominantly waterproof, readily compressible and easy to shape. In many respects, therefore, cork is a natural material to consider for sealing fluid in a container such as wine in a wine bottle.

There is always the danger when using any packaging material that contaminants in the material used to form the packaging will contaminate the final product leading to a consequent drop in final product quality. This is particularly true for packaging materials that are used to package fluid products. In many instances the performance characteristics of the packaging material may not properly take into account the effect of sustained contact between the packaging material and the fluid product during storage. Such an effect is exacerbated in relation to wine where product is frequently stored for long periods of time in the packaged state. The effect is particularly noticeable with stoppers as, in many instances, the characteristics of the material used to produce the stopper are designed to provide ease of use of the stopper during the packaging process rather than its performance during prolonged storage of the container. As a result, other performance characteristics of the stopper may be compromised.

A perfect example of how contaminants in a stopper can affect product quality is in the wine industry. The use of cork stoppers can lead to the development of undesirable product characteristics when used to stopper a container containing a wine. Cork can occasionally cause off flavours in wine and it is often the cause of musty or mouldy taint and sometimes the cause of off flavours due to oxidation. In 1994 the Quercus project was initiated by the European cork industry to reduce the occurrence of off flavours. Cork producers now follow the European Cork Federation's Code of Practise to reduce taint. TCA (2,4,6 Trichloroanisole) has been identified as the cause of some musty/mouldy taint. Although cork is not the only source of TCA in wine it has been shown that some corks contain levels of TCA which are transferred to wine when stored in bottles. It has also been observed that the taints can be transferred to the wine via the vapour when the bottles are left standing up and the liquid does not contact the cork surface. This is due to corks poor barrier to volatile materials, demonstrated by its readiness to absorb and desorb moisture vapour with changes in relative humidity and its susceptibility to the entry of the volatiles which may be retained and later transferred to wine.

Another aspect to be considered when packaging products is whether the product needs to be completely sealed off from the environment or whether gaseous exchange is desirable. For example, with bottle storage of wine consideration of the flavour development of the wine with aging has to be taken into account. The concept of bottle aging, bottle maturation or bottle development is well known, however, little is understood or scientifically proven in this area. There is some belief that the stopper breathes and that oxygen plays a role in bottle development of the wine, although it is well proven that too much oxygen will oxidise a wine and ruin it. There is a growing body of work that is developing the use of micro-oxygenation to develop flavour and mature wines. Any stopper for use in the wine industry therefore should preferably control the permeability of oxygen and allow in some cases some oxygen to permeate the stopper and come into contact with the wine and in other circumstances significantly block the ingress of oxygen.

A number of approaches have been developed aimed at overcoming the problems of contamination of the product by the stopper whilst at the same time preferably retaining control of oxygen permeability. It has been shown that coatings can be used to improve the performance of cork stoppers. Waxes and paraffins may be used as coatings and applied to corks to improve the sealing capability, for example. It has been observed that wax coatings also reduce the amount of liquid that soaks into the cork over time. Silicone coatings have also been applied to corks to improve the insertion and extraction of the cork. It is thought that the silicone reduces the friction between the cork and the bottle during both the insertion and extraction processes. Coatings of this type are typically applied to the corks while the corks are tumbling in a rotating drum. The corks may be tumbled with a solid wax block or a liquid is squirted or otherwise sprayed onto corks. The coating is then spread from cork to cork by the physical contact between the corks transferring the coating and evenly distributing it. Heat may also be applied to aid the process.

There have been several attempts to place other forms of physical barriers between the stopper and the wine to prevent the transmission of tainting components to the wine. Many of these attempts have worked on the principle of applying a coating layer on the end of the stopper in the form of a coating that is allowed to cure and dry as a film coating layer or in the form of a polymeric film attached to the end of the stopper. Unfortunately, the characteristics of the stoppers produced using these techniques has been unsatisfactory. Without wishing to be bound by theory, it is thought that the problem with these approaches is that whilst the stopper is compressible, the coating layer is typically not compressible. This leads to the development of imperfections in the coating layer such as cracking, peeling, creasing and the like. Patent application WO 00/34140 purports to overcome these problems and describes a composite stopper with a body and a thick moulded elastomer plug located at the end of the stopper. The elastomer plug provides a seal to the bottle and is claimed to be a taint barrier which allegedly prevents the wine touching the cork body of the stopper. The difficulty with this approach is that whilst it may overcome the taint problems it creates further problems and/or has a number of disadvantages. The unit cost of each stopper is significantly higher than the unit cost of cork stoppers in general and so is undesirable from an economic standpoint. In addition elastomer plugs of the type described in this patent have a high transmission rate for oxygen typically meaning that the use of a plug of this type would not be expected to reduce the oxidation of the wine occurring on storage. As the exact orientation of the stopper into the opening of the container is crucial for the performance of the stopper, expensive capping machinery is required in order to ensure adequate performance of the stopper once fitted. This markedly slows production of bottled product when these stoppers are used.

Another attempt to deal with taint from cork is disclosed in WO 00/64647 which provides a diffusion coating onto the cork layer. Like other coatings this approach suffers from the distortion of the coating when the cork is compressed. There have been many attempts to provide coatings or layers on corks but none of these have been commercially adopted.

An early proposal is disclosed in French patent 983488 which discloses a pre-molded cap that can be attached or glued to the end of the cap. There is no record of this proposal being adopted.

USA patent 4188457 discloses a thermoplastic synthetic cork containing a metabisulfite preservative. The introduction to this patent states that previous attempts to deal with taint had failed.

EU patent 532367 discloses a pre-molded cap that can fit on the end of a cork. In another embodiment coating of the end of the cork is suggested.

Eu patent 629559 discloses a composite synthetic stopper of complex design.

USA patent application 2002/0014468 discloses a stopper of natural cork with a jacket or coating to cover the core. Again this has the problems mentioned above for coatings

None of these proposals have been accepted as a solution to the problem of taint by the wine industry.

There have been two solutions to the problem of taint that have had some success with adoption by some in the wine industry. The first is to use wholly synthetic polymer corks which although effective are more expensive than natural cork. The second solution is the use of screw cap closures which again are more expensive than cork and also have the characteristic of not being suitable for wines that need bottle aging because the screw caps are virtually impermeable. Both these solutions break with tradition by abandoning natural cork.

It is an object of this invention to provide a cost effective means of controlling taint while still using the traditional natural cork stopper.

### SUMMARY OF THE INVENTION

The present invention provides a stopper which consists of a compressible body (3) of cork having at least one flat end face characterized in that the edge (8,9) of the end face is chamfered or beveled and a barrier film (1) is adhered to the end face so that on compression of the body on insertion of the stopper into a container opening the region of the stopper at the end face compresses without substantially adversely affecting the protective layer between the body and the contents.

In part this invention is predicated on a study made by the inventor that found that most of the deficiencies observed with prior art coating techniques were caused by radial compression of the stopper during insertion into the bottle neck. As a result these studies the inventor found that the observed problems were not caused by the compression of the stopper per se but by the non-uniform deformation of the coating or film on the stopper when the stopper was compressed. Lack of uniformity in deformation of the coating or film leads to the imperfections which compromise the integrity of the protective coating or layer. In this invention the chamfered or beveled edge avoids the formation of a wrinkled film when the stopper is radially compressed.

Preferably the ratio of the diameter of the end face within the chamfered edge to the diameter of the uncompressed stopper body is less than 1 preferably less than 0.9. Preferably the barrier film does not extend beyond the end face of the uncompressed stopper.

The barrier film is preferably selected from ethylene vinyl alcohol copolymers, polyvinyldene chloride, and metal foils.

In another aspect this invention provides a method of forming a stopper in which a stopper of natural cork having at least one end face, is treated to form a chamfer on the edge of said end face and a laminate consisting of a barrier film and an adhesive layer is pressed with the application of heat against the end face and edge to adhere the barrier layer to the end face and edge.

Throughout this specification the term “film” is used in the sense that at is understood by those skilled in polymeric packaging materials. In packaging a polymeric film is intended for wrapping and is thin and flexible in all directions and is distinct from sheets which are more rigid and intended for thermoforming articles such as packaging trays. Similarly the term “laminate” means a film laminate as used in packaging.

### DESCRIPTION OF THE FIGURES

FIG. 1. This shows a fragmentary side view of one end of a preferred stopper of the invention.

FIG. 2. This shows a side view of another preferred embodiment of the stopper of the invention.

FIG. 3. This shows a fragmentary longitudinal section of an end of a preferred stopper of the invention.

FIG. 4. This shows a longitudinal view of yet a further preferred stopper.

FIG. 5. This shows a plan view of the stopper of FIG. 3 looking down line V-V of FIG. 3.

FIG. 6. A side view of a preferred stopper of the invention.

FIG. 7. This shows a fragmentary longitudinal view of a preferred stopper of the invention.

FIG. 8. This shows a fragmentary longitudinal view of another preferred stopper of the invention.

FIG. 9. This shows a stopper located in a die prior to the application of a film to the end of the stopper.

FIG. 10. This shows the stopper in the die prior to the backing plates forcing film onto the two ends of the stopper.

### DETAILED DESCRIPTION OF THE INVENTION

A requirement of a stopper for containers for the mass production of a packaged product is the ability of the stopper to withstand the conditions imposed on the stopper during manufacture of the finished product. One of the principle conditions typically imposed upon stoppers irrespective of the industry in which they are utilised is that the stopper is compressed at least partially prior to its insertion into an opening in a container. The stopper then typically expands once the compression force is released leading to a tight fit of the stopper in the container opening. The stopper usually forming an interference fit with the opening in the container. In the wine industry bottling operations typically utilise high speed stoppering machines which subject the stoppers to large compression forces. These machines typically utilise a number of compression jaws which radially compress the stopper body from its normal diameter to a substantially smaller diameter, typically about one third of the original size. A ram is then utilised to force the stopper from the jaws of the compression machine directly into the opening of the container where the stopper attempts to expand to its original diameter, thus sealing the bottle. A typical cork used in the wine industry is approximately 45 mm long with a diameter of approximately 24 mm. A typical internal diameter of the opening of a wine bottle is about 18 mm. Significant compression of a stopper therefore occurs in packaging of wine.

The stopper of this invention is formed from natural cork cut whole from the cork bark, from natural cork crumb glued and compressed to form a stopper and includes stoppers with an end face contacting the wine that is made from natural cork. It is preferred that the dimensions of the stopper are such that it is from 30-60 mm in length, more preferably from 35-55 mm in length, even more preferably from 37-47 mm in length, most preferably about 38 mm or about 45 mm in length. The stopper body is preferably cylindrical with a diameter of from 18-30 mm, more preferably from 22-26 mm, even more preferably from 23-25 mm, most preferably 24 mm.

The stoppers of the present invention can be used with any container having an opening which can be sealed with a stopper. It is preferred that the container is a bottle and the stopper is shaped to fit into the opening of the bottle, namely the mouth of the bottle.

The stoppers of the invention have a film on at least one end of the body which provides a protective layer between the body of the stopper and the contents of the container once the stopper has been inserted into the container opening. If the stopper body only has one end, the film is located on that end. If the stopper body has more than one end, the film may be on only one of the ends or on a number of ends. Thus, where the stopper body has two ends, the film may be on only one end or may be on both ends. If there are two ends it is preferred that the film is on both ends.

It is preferred that the film only covers the end of the body and does not travel beyond the end of the uncompressed body such as down the sides of the body. It is preferred, therefore, that the film completely covers the end of the uncompressed stopper but does not travel beyond the end of the stopper.

The improved stoppers in accordance with the invention may utilise a number of different films. The film may be a coating layer that has been applied as a liquid and allowed to cure or a coating layer that has been sprayed on or otherwise applied to the stopper body. The film may also be a polymeric film.

It is preferred that the film is a polymeric film, preferably a multilayer polymeric film. The polymeric film preferably comprises a barrier layer and an adhesive layer. The barrier layer preferably has a low permeability to H₂O, O₂ and CO₂ and is preferably substantially impermeable to organic molecules with molecular weights greater than 40. A number of materials are known that can be used to produce barrier layers for use in the invention stopper. Preferably, the barrier layer comprises one or more polymers or materials selected from the group consisting of polyethylene, polypropylene, polyethylene Terepthalate, ethylene-vinylacetate polymers, polyvinylchloride, polydivinylchloride, polyvinyldichloride, polyvinylacetates, nylon, polyvinyl alcohols, polyurethane, polyacrylonitrile, cellophane, surane, polyamines, polycarbonates, polystyrene, polyalkylene oxides, polyethylene oxides, cellulose, cellulose derivatives, and silicon polymers or metal foils. A preferred barrier layer comprises nylon or cellulose, polyethylene and PVDC or metal or EVOH. The barrier layer may be any thickness typically utilised in the art. It is preferred that the barrier layer is between 1 to 50 micron, preferably 2 to 40 micron, more preferably 5 to 30 micron, most preferably 10 to 30 micron.

The film also preferably includes an adhesive layer. The adhesive layer may be added to the film prior to application to the stopper body by way of a spray or may be laminated onto the film prior to application of the film to the stopper body. Suitable adhesive layers include those selected from the group consisting of hot melt adhesives or heat activated adhesives. Suitable adhesives therefore include polyethylene vinyl acetate, polyamides, acrylics, methyl methacrylate based polymers, starch based adhesives, carbohydrate based adhesives, protein based adhesives, animal glues, rubbers, silicones, epoxy resins, melamine-formaldehyde based adhesives, unsaturated polyesters, urea-formaldehyde resins, resorcinols, phenolic adhesives, urethanes, polysulfides, polyvinyl and ethylene vinyl acetate polymers. Particularly preferred adhesive layers are ethylene vinyl acetate polymers.

The adhesive layer preferably has a thickness of between 0.1 to 15 micron, more preferably 4 to 15 micron, most preferably 10 to 15 micron. If a heat activated adhesive is used, it preferably has an activation temperature greater than 30° C., more preferably greater than 50° C., most preferably greater than 80° C.

The stoppers of the invention have at least a region at an end of the compressible body which has at least one property such that upon compression of the body for insertion into an opening of a container, the region compresses without substantially adversely affecting the protective layer provided by the film. If the body has more than one end, a region of this type may be located at either end or there may be a region located at each end. The region may be integral with the remainder of the stopper body or may be attached to the remainder of the stopper body to form a composite stopper body. There are a number of properties the region may have which will provide the desired result.

One property of the region is for it to taper toward the end at which it is located in such a way that the end of the stopper has a surface area that is less than the cross-sectional area of the remainder of the stopper body. In one preferred embodiment therefore, the property of the end of the stopper that provides an improved stopper is that at least a portion of the region at the end of the stopper tapers towards the end of the compressible body. The taper is such that the cross-sectional area of the end is less than the cross-sectional area of the body. It is found that only minor tapers are required as only minor reductions in the cross-sectional area of the end of the stopper body are required to maintain the protective integrity of the film. The taper is preferably such that the cross-sectional area of the end is less than 98% of the cross-sectional area of the body, more preferably less than 96%, even more preferably less than 92%, more preferably less than 85%, even more preferably less than 80%, yet more preferably less than 75%, most preferably less than 70% of the cross-sectional area of the body. Particularly preferred ranges of the taper are such that the cross-sectional area end of the stopper is between 65% and 85% of the cross-sectional area of the body. Without wishing to be bound by theory, it is though that such a reduction allows for the control of the deformation of the film on compression of the body.

It has been found that any of a number of different tapers can be used to provide the desired performance characteristics. For example, the taper may be a uniform or a non-uniform taper. By uniform taper it is meant that the reduction in thickness of the stopper body is constant as it approaches the end. It is preferred, however, that the taper is a uniform taper as this is most easily mass produced and therefore the most desirable economically. At least in principle, however, any type of taper may be used. Thus, the side of the body as it tapers may be straight or curved in shape. It is preferred that the taper not be so extensive that the end of the body on which the film is located become smaller than the opening of the bottle it is intended to seal. If this occurs, there is a compromise of the effectiveness of the protective layer provided by the film. It is preferred that the taper only continue for a minor portion of the stopper body. It is preferred that the taper occurs on less than 30% of the stopper body, even more preferably less than 20% of the stopper body, more preferably less than 10%, yet even more preferably less than 5%, even more preferably on less than 2%, most preferably less than 1% of the stopper body. It is found that the taper is equally effective if it is located essentially only at the end although in principle, the taper may traverse almost the entire length of the stopper body. One preferred method of forming the taper of the stopper body is to produce a stopper and then chamfer the end to achieve a tapered stopper body. This step of chamfering the stopper body may occur either before or after the attachment of a film to the end of the body. The following tables (1) and (2) list the relative surface area with different size chamfers for a number of different size stopper body diameters.

TABLE 1

| | Total Chamber Size (mm) | | | | | | |
|---|---|---|---|---|---|---|---|
| Cork Dia | 0 | 0.2 | | 0.5 | | 1 | |
| (mm) | Sa | Sa | Ra | Sa | Ra | Sa | Ra |
| 22 | 380.13 | 373.25 | 0.982 | 363.05 | 0.955 | 346.46 | 0.911 |
| 23 | 415.48 | 408.28 | 0.983 | 397.61 | 0.956 | 380.13 | 0.914 |
| 23.5 | 433.74 | 426.38 | 0.983 | 415.48 | 0.957 | 397.61 | 0.916 |
| 24 | 452.39 | 444.88 | 0.983 | 433.74 | 0.958 | 415.48 | 0.918 |
| 24.5 | 471.44 | 463.77 | 0.984 | 452.39 | 0.959 | 433.74 | 0.920 |
| 25 | 490.87 | 483.05 | 0.984 | 471.44 | 0.960 | 452.36 | 0.921 |
| 30 | 706.86 | 697.47 | 0.987 | 683.49 | 0.966 | 660.52 | 0.934 |

TABLE 2

| | Total Chamber Size (mm) | | | | | | |
|---|---|---|---|---|---|---|---|
| Cork Dia | 0 | 2 | | 3 | | 4 | |
| (mm) | Sa | Sa | Ra | Sa | Ra | Sa | Ra |
| 22 | 380.13 | 314.16 | 0.826 | 285.53 | 0.745 | 254.47 | 0.669 |
| 23 | 415.48 | 346.36 | 0.833 | 314.16 | 0.756 | 283.53 | 0.682 |
| 23.5 | 433.74 | 363.05 | 0.837 | 330.06 | 0.760 | 298.65 | 0.688 |
| 24 | 452.39 | 380.13 | 0.840 | 346.36 | 0.765 | 314.16 | 0.694 |
| 24.5 | 471.44 | 397.61 | 0.843 | 363.05 | 0.770 | 330.06 | 0.700 |
| 25 | 490.87 | 415.46 | 0.846 | 380.13 | 0.774 | 346.36 | 0.705 |
| 30 | 706.86 | 615.75 | 0.871 | 572.56 | 0.81 | 530.93 | 0.751 |

In the tables, total chamfer size indicates the total amount of chamfer when the chamfer at the two sides of the body are added together. Thus, with a chamfer size of 2, there has been approximately 1 mm of stopper body removed from each side.

Sa=Surface area (mm²)

Ra=Surface area of end of chamfered cork/cross-sectional area of cork

It is preferred that the stopper body has two ends. It is particularly preferred when using the property of a tapered body to produce the improved stoppers that where there are two ends, then both of the ends of the compressible body are tapered. If this occurs, it is preferred that both ends are tapered in the same manner and to the same extent. The advantage of this is that stoppers of this type can be used in conventional bottling machines which do not discriminate between the two ends of the stopper. Therefore, using stoppers with two ends with similar tapers on the ends allows the stopper to perform the desired function irrespective of the end of the stopper selected by the machine for insertion into the bottle.

In addition to machining a stopper body (either before or after application of a film) to achieve the taper discussed above, the taper may also be achieved by attaching a pre-tapered layer or disc to one or more ends of a stopper body to produce a composite stopper body with a tapered region at least, one end. Whilst this technique can be utilised, it is not preferred as it is not cost-effective as these stoppers then become expensive to produce relative to the machining technique. As would be clear to a skilled addressee, a combination of these techniques may be used. Of course, with stopper bodies that are produced by moulding processes, the taper may be built into the mould leading to a formed stopper having a taper.

In the process of the invention the film is heated prior to or simultaneously with the pressing step. The heating may be achieved in a number of ways including pre-heating of the film prior to the pressing step by means of a heated blast of air or other gas blown over the surface of the film. It is also possible for the film to be passed through a heating chamber or heated zone prior to the pressing step in which case heat is transferred to the film in the heating chamber or heating zone. The heating can also be applied by heating the die holding the stopper or, alternatively, the backing plate that forces the film on to the stopper can be at an elevated temperature such that heat is transferred to the film on pressing. It is preferred that the heating is such that the film is heated to at a temperature sufficient to soften, melt or activate the outer layer of the film typically at least 40° C., preferably at least 80° C., more preferably at least 120° C.

In the process of the invention, the film and the surface of the stopper are pressed relatively together so as to attach the film to the surface. There are a number of ways in which the relative pressing together of the polymeric film and the stopper surface can be achieved. Thus, for example, the polymeric film can be held in place and the stopper surface pressed against the film. If this is the case, a backing plate is typically utilised to ensure the film does not deform away from the stopper on pressing. Alternatively, both film and die may move relative to each other to press the stopper surface and polymeric film together. It is preferred, however, that the stopper is held relatively securely and the film pressed onto the surface of the stopper by way of a moveable backing plate. It is preferred that the backing plate cooperates with the die in which the stopper is held during pressing to cut the film such that the film is only located on the surface of the end of the stopper. It is preferred that the pressing is carried out with sufficient force to compress the compressible body of the stopper by at least 0.5%, more preferably at least 1%, more preferably at least 2%, yet even more preferably at least 3%, even more preferably at least 10%, most preferably at least 15%. The pressing step may in theory be carried out for any period of time. It is preferred, however, that it is carried out for between 0.1 to 60 seconds, more preferably 0.1 to 15 seconds, most preferably 0.1 to 5 seconds. On completion of pressing the force is removed by removing the backing plate.

The process of invention can occur in such a way that only one end of the stopper is treated or, alternatively, both ends of the stopper can be simultaneously treated by the process described above. In this manner, two backing plates are utilised with two polymeric films. Upon completion of the pressing step, the backing plate or plates are released so as to reduce pressure. If the process is run as a continuous process, the film is then advanced, a further stopper is provided and the process repeated. One way of achieving this is to have a number of dies arranged on an axle or slide wherein, after treatment of one stopper is complete, the axle or slide advances to a further position to present a new stopper to be treated and the treated stopper is punched out with a ram and replaced. This allows the process to be relatively efficient and time and cost-effective and can therefore be run as a continuous process.

The above description provides an overview of the inventive stopper and process of the invention. The invention will now be further described with reference to the accompanying drawings.

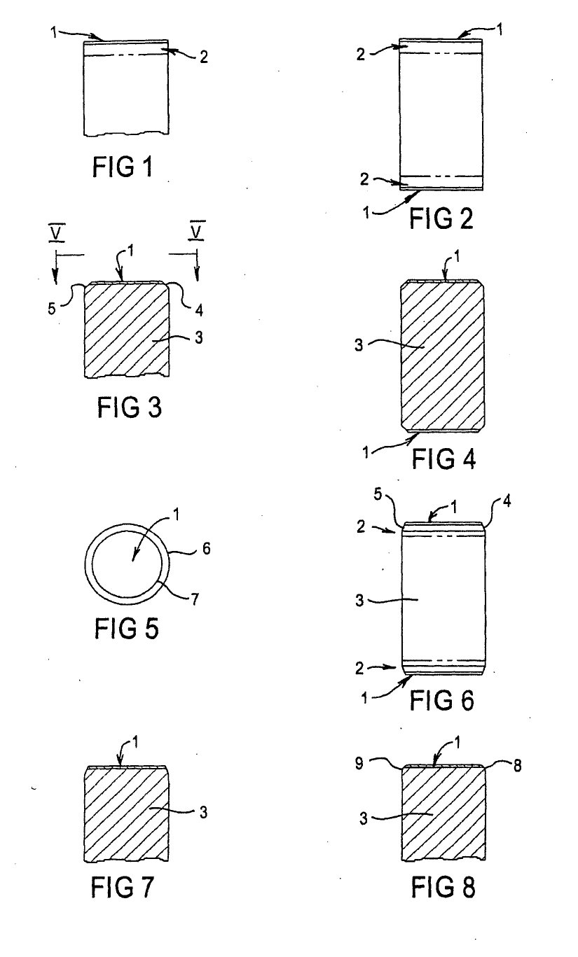

A fragmentary view of one end of the stopper is shown in FIG. 1. There is a film (1) on the end of the stopper body and a region (2) at the end of the stopper body that is substantially uniformly compressible in the plane of the surface presented by the region at the end of the stopper body.

FIG. 2 shows a view of yet a further preferred stopper of the invention with film (1) located on each end. There are regions (2) at each end of the stopper, each of the regions being substantially uniformly compressible in the plane of the surface at the end of the stopper presented by the region. In this embodiment this substantially uniformly compressible region is located at each end of the stopper and allows for use of the stopper in automated stoppering machines.

FIG. 3 shows a cross-sectional fragmentary view of yet a further preferred stopper of the invention. The stopper in FIG. 3 incorporates a taper. There is a film (1) located on the end surface of the stopper body (3) with the taper at the end of the stopper body indicated by tapering sides (4) and (5), being such that the cross-sectional area of the surface of the end of the stopper on which the film (1) is located, being less than the cross-sectional area of the stopper body.

FIG. 4 is a cross-sectional side view of a preferred stopper of the invention with a taper at both ends. A film (1) is located on each end of the stopper body (3). Each end of the stopper body tapers as shown such that the surface area of the ends covered by the film (1) is less than the cross-sectional area of the stopper.

FIG. 5 shows a plan view looking down line V-V shown in FIG. 3. The outer ring (6) represents the sides of the stopper body and the inner ring (7) represents the surface at the end of the stopper body after the taper.

FIG. 6 represents a particularly preferred embodiment of the invention. This embodiment demonstrates the combined effect of a taper and a substantially uniformly compressible region at the end of the body. The stopper has a stopper body (3) with a film (1) located on each end. At each end of the stopper body, there are substantially uniformly compressible regions (2) with at least a portion of each of the regions being tapered such that each of the ends has a cross-sectional area that is less than the cross-sectional area of the body. The tapered body sides (4) and (5) are clearly shown.

FIGS. 7 and 8 show different preferred tapers at the ends of the stopper body. Thus, in FIG. 7 there is a stopper body (3) with a film (1) on the end thereof. There are tapered sides (4) and (5). The extent of the taper in FIG. 7 is less than the taper shown in FIGS. 3 and 4 and shows how the angle of the taper can be varied.

In FIG. 8 there is a stopper body (3) with a film (1) located on one end. In this case, the edges (8) and (9) are tapered such that they are rounded with the end of the stopper having a lower cross-sectional area than the cross-sectional area of the stopper body.

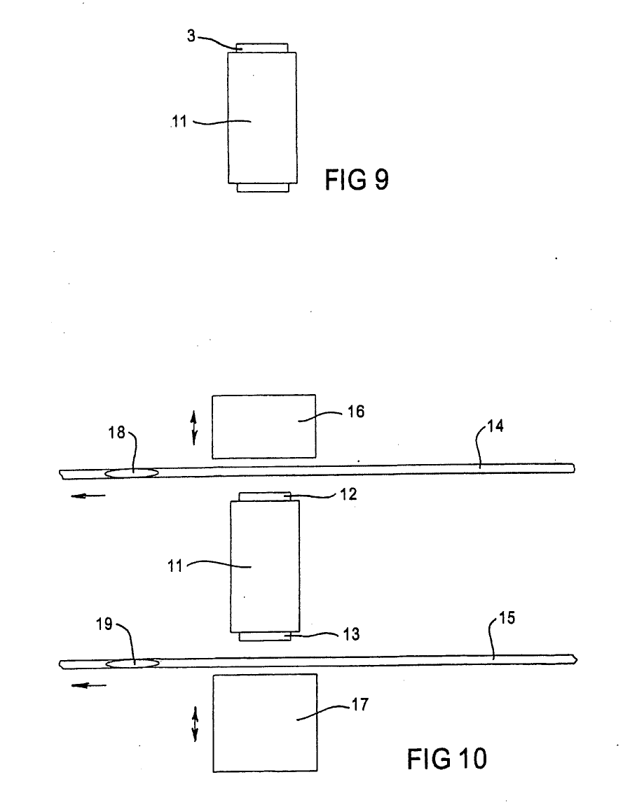

FIG. 9 shows a stopper body (3) located with a stopper holding means. The two ends of the stopper protrude from the ends of the stopper holding means.

FIG. 10 is a schematic of the process of the invention immediately prior to the pressing step. There is a stopper holding means (11) with two ends of a stopper (12) and (13) protruding therefrom as in FIG. 9. There are two polymeric films (14) and (15) provided as part of a continuous film and backing plates (16) and (17) which are arranged to press the film onto the ends of the stopper. After the compression is complete, the backing plates (16) and (17) are released and the film advances in the direction shown to treat a further stopper. As shown, the polymeric films include voids (18) and (19) showing where polymeric film has been punched out of the continuous film during treatment of the previous stopper.

The present invention will now be more fully described with reference to the accompanying example. It should be understood, however, that the description following is illustrative only and should not be taken in any way as a restriction on the generality of the invention described above.

### Example 1

### Coating Films Preparation

A 20 micron multilayer film containing a 15 micron high density polyethylene layer with a 5 micron ethylene-vinyl acetate copolymer (EVA) layer was produce using conventional coextrusion blown film equipment.

A 40 micron multilayer film containing layers of EVA/PE/PVDC/Nylon was produced by extrusion and laminating using conventional techniques.

Producing Cork Stoppers with End Film Coating

A cutting tool was manufactured 26 mm in diameter with an internal cylindrical cavity 42 mm deep. Corks of 24 mm diameter, 45 mm length were taken from a batch of commercial corks. The ends the corks were coated with both the EVA/PE/PVDC/Nylon film and polyethylene/EVA film in one step using the tool described by pressing the cork onto a heated backing plate (125° C.) with the cork inside the cutting tool, the films held between the cork and the backing plate. Each of the corks was then measured to determine the ratio of the diameter of the film versus the diameter of the cork.

$$∴ R = \frac{Diameter of the film}{Diameter of the cork body}$$

Thus, where the film was located only on the end of the stopper body and completely covering it R=1.00. Where there was an overlay of film over the end of the stopper R=1.08.

Chamfering the Coated Corks to Reduce the R Value

A number of the coated corks were then chamfered by rotating the edges on sandpaper to produce tapered corks. In these cases, the cross-sectional area of the surface of the stopper was less than the cross-sectional area of the body of the stopper. R values of 0.92, 0.83, 0.79 and 0.75 were thereby produced.

Wax and Silicone Coating

The corks were waxed and silicone coated by tumbling 100 corks with solid paraffin wax for 20 minutes and then with squirting 1 ml of 7004 CAF silicone on the corks and tumbling for a further 30 minutes. This was done to improve insertion of the corks into the bottle neck.

The Effect of R and the Ratio of the Surface Area of the End of the Stopper Value on Gas Transmission

The amount of air that enters the bottle at bottling can be seen by applying a vacuum at bottling and inverting the bottle and watching the air bubbles that stream into the bottle. (0—no streaming; 5—maximum amount of streaming)

| | | | Quantity of bubbles |
|---|---|---|---|
| R value | Area | Ra | entering bottle |
| 1.08 | 531 | 1.17 | 5 |
| 1.0 | 453 | 1 | 4 |
| 0.92 | 380 | 0.84 | 3.5 |
| 0.83 | 314 | 0.69 | 1 |
| 0.79 | 284 | 0.63 | 0 |
| 0.75 | 255 | 0.56 | 1.5 |

Ra=Surface area of end of stopper/cross-sectional area of the stopper.

It is clear that oxygen transmission is at optimal levels when the stopper body has a taper. As would be clear to a skilled addressee, it would be expected that the optimal taper will vary according to the properties of the compressible material of the stopper, the properties of the coating film and the dimensions of the opening into which it is ultimately inserted.

### Example 2

Cork Travel Test

Another test that distinguishes the sealing ability of corks is known as the Travel Test. This test measures the number of bottles that allow wine to travel up between the cork and the bottle neck. The distance the wine travels is recorded. The test is accelerated by laying the bottles down and heating them to 30° C. for a week. The heat increases the pressure the wine exerts on the seal. With film coated corks travel is usually associated with wine soaking underneath the film. The degree of this under soak can also be measured.

Four coated corks were tested by this method. Some of the corks were altered by gluing a 4 mm thick transverse cut cork disk onto the end of the cork prior to coating with a polymer film. Each cork type was 24 mm diameter by 44 mm long in their completed form.

Transverse cut means the disk was cut in a direction perpendicular to the direction cork for wine stoppers is usually cut. The end face of the disk originally faced into or away from the tree trunk. Therefore the lenticels (or air holes that originally allowed air to pass through the bark to the tree) pass from one face of the disk to the other. Natural cork stoppers are not cut in this direction because the wine can travel up through the lenticels from the inside end of the cork to the outside end. Usually, the end face of a cork stopper originally faced either the ground or the sky and the lenticels pass across the body of the cork. When compressed radially the transverse cut disk, although not precisely uniform, has a much greater uniformity of deformation than the usually cut cork stopper. Meaning that when a force is applied at the edge of the disk towards the disk's centre, the deformation is similar to the deformation achieved when a similar force is applied to another point on the edge of the disk and directed towards the centre of the disk. When cork is cut in the usual way with the ends originally pointing to the ground and sky, the deformation uniformity is poor due to growth rings and the shape and orientation of the unit cells making up the cork.

The four cork types were
1. Straight natural cork
2. Straight natural cork with 2 mm diameter chamfer
3. Cork with a transverse cut cork disk glued on end
4. Cork with a transverse cut cork disk glued on end with a 2 mm chamfer.

Prior to any chamfering being done, each of the corks was coated with a 60 micron film consisting of the layers EVA/PE/PVDC/Nylon/EVA/HDPE by heating and pressing the film onto the cork at 125° C. as described in example 1. Prior to bottling, the corks were coated with wax and silicone by tumbling for 60 minutes with approximately 0.0087 g wax and 0.0064 g of silicone per cork. The travel and under film soak results for six repeats of each cork after storage at 30° C. for three weeks were as shown in the following table.

| | | | | | % with soak |
|---|---|---|---|---|---|
| | | | % travel | % with no | under film |
| Cork | % without | % travel less | greater | soak under | greater than |
| No | travel | than 5 mm | than 5 mm | the film | 30% of area |
| 1 | 0 | 50 | 50 | 0 | 83 |
| 2 | 0 | 100 | 0 | 33 | 33 |
| 3 | 67 | 33 | 0 | 83 | 13 |
| 4 | 100 | 0 | 0 | 100 | 0 |

It is clear from the above that stoppers with a chamfered end have improved performance characteristics as opposed to natural cork. It is also clear that the use of a substantially uniformly compressible region or layer on the end of the stopper body also improves stopper performance. A combination of these features is clearly superior.

What is claimed:

1. A stopper which consists of a compressible body (3) of cork having at least one flat end face characterized in that the edge (8,9) of the end face is chamfered or beveled and a barrier film (1), which does not extend beyond the end face of the uncompressed stopper, is adhered with a layer of heat activated adhesive, to the end face so that on compression of the body on insertion of the stopper into a container opening the region of the stopper at the end face compresses without substantially adversely affecting the protective layer between the body and the contents.

2. A stopper as claimed in claim 1 in which a ratio of the diameter of the end face within the chamfered edge to the diameter of the uncompressed stopper body is less than 1 and preferably less than 0.9.

3. A stopper as claimed in claim 1 in which the barrier film (1) is selected from ethylene vinyl alcohol copolymers, polyvinyldene chloride, and metal foils.

4. A method of forming a stopper as claimed in claims 1 in which a stopper having at least one end face is treated to form a chamfer (4,5) on the edge of said end face and a laminate (1) consisting of a barrier film and a heat activated adhesive is pressed with the application of heat against the end face and edge to adhere the barrier layer to the end face and edge.

5. A packaged product comprising
a. a container having an opening
b. a product located within said container
c. a container stopper as defined in claim 1, inserted into said opening.
